(19) United States
(12) Patent Application Publication
(10) Pub. No.: US 2016/0052687 A1
(43) Pub. Date: Feb. 25, 2016

(54) Drum Closure with Vertical Channel

(71) Applicant: International Precision Components Corporation, Lake Forest, IL (US)

(72) Inventors: Michael D. Stolzman, Lake Forest, IL (US); Kenneth J. Kuzelka, Island Lake, IL (US)

(21) Appl. No.: 14/466,716

(22) Filed: Aug. 22, 2014

(51) Int. Cl. B65D 53/06; B65D 1/42; B32B 37/18; B32B 37/12; B32B 37/14; B65D 1/16; B65D 43/02

(52) U.S. Cl. CPC B65D 53/06; B65D 1/16; B65D 1/42; B65D 43/0202; B32B 37/1292; B32B 37/142; B32B 37/18; B32B 2439/00

(57) ABSTRACT

A container is provided. The container includes a sidewall, a lower closure, and a chime. The chime is coupled to a first end of the sidewall by adhesive. The lower closure is coupled to a second end of the sidewall by adhesive.

### BACKGROUND OF THE INVENTION

The present invention relates generally to the field of containers and more specifically to relatively large shipping containers such as fiber drums with plastic closures.

Drums or barrels may be used to ship bulk dry and liquid goods.

### SUMMARY OF THE INVENTION

One embodiment of the invention relates to a shipping drum. The shipping drum includes a fibrous cylindrical sidewall extending along a longitudinal axis from a first end to a second end. The sidewall has an inner surface and an outer surface. The shipping drum includes a lower closure formed from plastic. The lower closure includes a central portion extending radially outwardly from a central longitudinal axis and inner and outer walls extending generally parallel to the central longitudinal axis. The inner and outer walls are located proximate the radial periphery of the central portion. The lower closure includes a channel wall extending between the inner and outer walls. The outer wall, the inner wall, and the channel wall define a channel configured to receive the second end of the sidewall therein. The lower closure includes a first rib. The first rib has a first portion that extends radially outwardly into the channel from the inner wall and in a direction axially generally parallel to the central longitudinal axis. The first rib has a second portion. The second portion extends axially upwardly from the channel wall into the channel and radially outwardly from the inner wall to the outer wall. The drum includes an adhesive coupling the sidewall to the inner and outer walls of the lower closure closing the second end of the cylindrical sidewall.

Another embodiment of the invention relates to a shipping drum. The shipping drum includes a fibrous cylindrical sidewall extending along a longitudinal axis from a first end to a second end having an inner surface and an outer surface. The lower closure is formed from plastic and includes a central portion extending radially outwardly from a central longitudinal axis. The lower closure includes inner and outer walls located proximate the radial periphery of the central portion. The inner and outer walls define a channel therebetween configured to receive the second end of the sidewall therein. The lower closure includes an outer surface of the inner wall defining a first axial channel extending axially generally parallel to the central longitudinal axis. An inner surface of the outer wall defines a second axial channel extending axially generally parallel to the central longitudinal axis. The shipping drum includes an adhesive coupling the sidewall to the inner and outer walls of the lower closure closing the second end of the cylindrical sidewall.

Another embodiment of the invention relates to a shipping drum. The shipping drum includes a fibrous cylindrical sidewall extending along a longitudinal axis from a first end to a second end. The fibrous cylindrical sidewall has an inner surface and an outer surface. The fibrous cylindrical sidewall has a first thickness. The shipping drum includes a lower closure. The lower closure is formed from plastic. The lower closure includes inner and outer walls extending in a direction generally parallel to a central longitudinal axis of the lower closure. The lower closure includes a first wall extending between the inner and outer walls. The inner and outer walls and the first wall define a channel configured to receive the second end of the sidewall therein. The lower closure includes a plurality of ribs spaced apart around the channel. The ribs extend from the first wall axially upwardly into the channel and radially outwardly from the inner wall to the outer wall. The shipping drum includes an adhesive coupling the sidewall to the inner and outer walls of the lower closure closing the second end of the cylindrical sidewall.

Another embodiment of the invention relates to a method of making a shipping drum. The method includes applying liquid adhesive into a channel of a plastic lower closure formed between inner and outer walls. The inner and outer walls extend in a direction generally parallel to a longitudinal axis of the lower closure. The inner wall includes a first rib extending radially outwardly into the channel and in a direction generally parallel to the longitudinal axis. The outer wall includes a second rib extending radially inwardly into the channel and in a direction generally parallel to the longitudinal axis. The method includes moving a first end of a generally cylindrical fibrous sidewall into the channel.

Alternative exemplary embodiments relate to other features and combinations of features as may be generally recited in the claims.

### BRIEF DESCRIPTION OF THE DRAWINGS

This application will become more fully understood from the following detailed description, taken in conjunction with the accompanying figures, wherein like reference numerals refer to like elements in which:

FIG. 1 is a perspective view of a drum according to an exemplary embodiment.

FIG. 2 is an exploded view of a drum according to an exemplary embodiment.

FIG. 2A is an exploded view of another drum according to an exemplary embodiment.

FIG. 3 is a perspective view of a chime according to an exemplary embodiment.

FIG. 4 is a perspective view of a chime with a portion of an outer wall removed according to an exemplary embodiment.

FIG. 5 is a bottom view of a chime according to an exemplary embodiment.

FIG. 6 is a detail view of the area 6 in FIG. 5.

FIG. 6A is a cross-sectional view of a chime according to an exemplary embodiment.

FIG. 6B is a detail view of the area 6 in FIG. 5 shown in a perspective view.

FIG. 7 is a perspective view of a chime coupled to a sidewall according to an exemplary embodiment.

FIG. 8 is a cross-sectional view taken along the line 8-8 in FIG. 7.

FIG. 9 is a detail view of the area 9 in FIG. 8.

FIG. 10 is a perspective view of a chime coupled to a sidewall according to an exemplary embodiment.

FIG. 11 is a cross-sectional view taken along the line 11-11—in FIG. 10.

FIG. 12 is a perspective view of a closure according to an exemplary embodiment.

FIG. 13 is a perspective view of a closure coupled to a chime according to an exemplary embodiment.

FIG. 14 is a cross-sectional view taken along the line 14-14 in FIG. 13.

FIG. 15 is a cross-sectional view taken along the line 15-15 in FIG. 13.

FIG. 16 is a perspective view of a lower closure.

FIG. 17 is a top view of a lower closure.

FIG. 17A is a cross-sectional view taken along the line 17A-17A in FIG. 17.

FIG. 17B is a cross-sectional view taken along the line 17B-17B in FIG. 17.

FIG. 18 is a detail view of the area 18 in FIG. 17.

FIG. 19 is a detail view of the area 18 in FIG. 17 shown in perspective view.

FIG. 20 is a detail cross-sectional view of a portion of a lower closure according to an exemplary embodiment.

FIG. 21 is a perspective view of a lower closure coupled to a sidewall according to an exemplary embodiment.

FIG. 22 is a cross-sectional view taken along the line 22-22 in FIG. 21.

FIG. 23 is a detail view of the area 23 in FIG. 22.

FIG. 24 is a detail view of a lower closure coupled to a sidewall according to an exemplary embodiment.

FIG. 25 is a perspective view of a drum according to an exemplary embodiment.

FIG. 26 is an exploded view of a drum according to an exemplary embodiment.

FIG. 27 is a perspective view of a chime according to an exemplary embodiment.

FIG. 28 is a side view of a chime according to an exemplary embodiment.

FIG. 29 is a bottom view of a chime according to an exemplary embodiment.

FIG. 30 is a bottom perspective view of an upper closure according to an exemplary embodiment.

FIG. 31 is a perspective view of an upper closure coupled to a chime according to an exemplary embodiment.

FIG. 32 is a cross-sectional view taken along the line 32-32 in FIG. 31.

FIG. 33 is a cross-sectional view taken along the line 33-33 in FIG. 31.

### DETAILED DESCRIPTION

Referring generally to the figures, various embodiments of containers, illustrated as drums or barrels, e.g., for shipping and/or storage, etc., are provided. The structures of embodiments of fiber-wall drums disclosed herein are configured to permit relatively large drum capacities, e.g., 55 gallon, etc. Embodiments of drums disclosed herein generally include a cylindrical sidewall formed from a first material and a lower closure formed from a second material configured to be coupled to a first end of the sidewall to close a first end of the sidewall. The drums also include an annular top portion, such as a plastic chime, configured to be coupled to a second end of the sidewall. The drums also include a cover, such as a plastic cover, configured to be releasably coupled to the chime to close a second end of the sidewall, e.g., after filling of the drum.

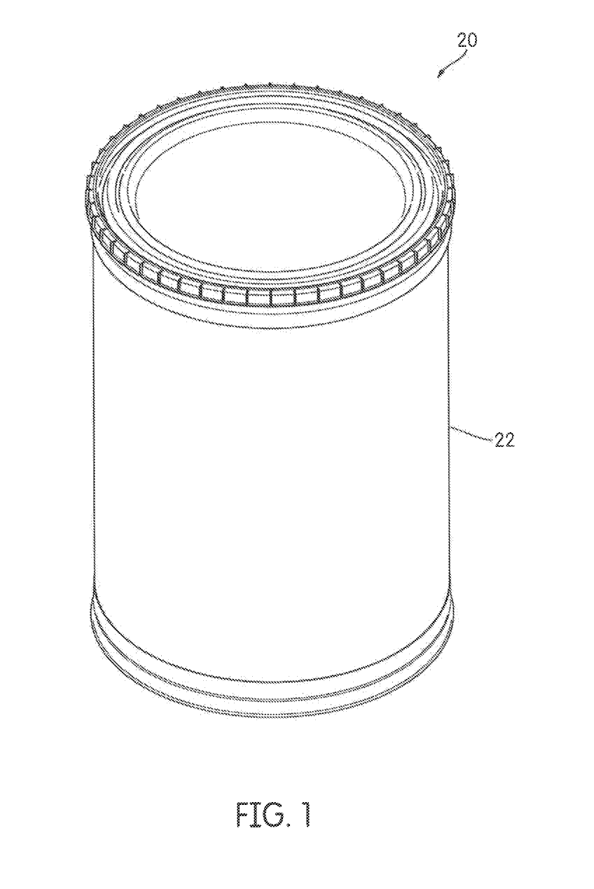

Referring to FIG. 1, an embodiment of a container, illustrated as a drum 20, is provided. The drum 20 includes a cylindrical sidewall 22. In one embodiment, the sidewall is formed of fibrous material such as, for example, fiberboard.

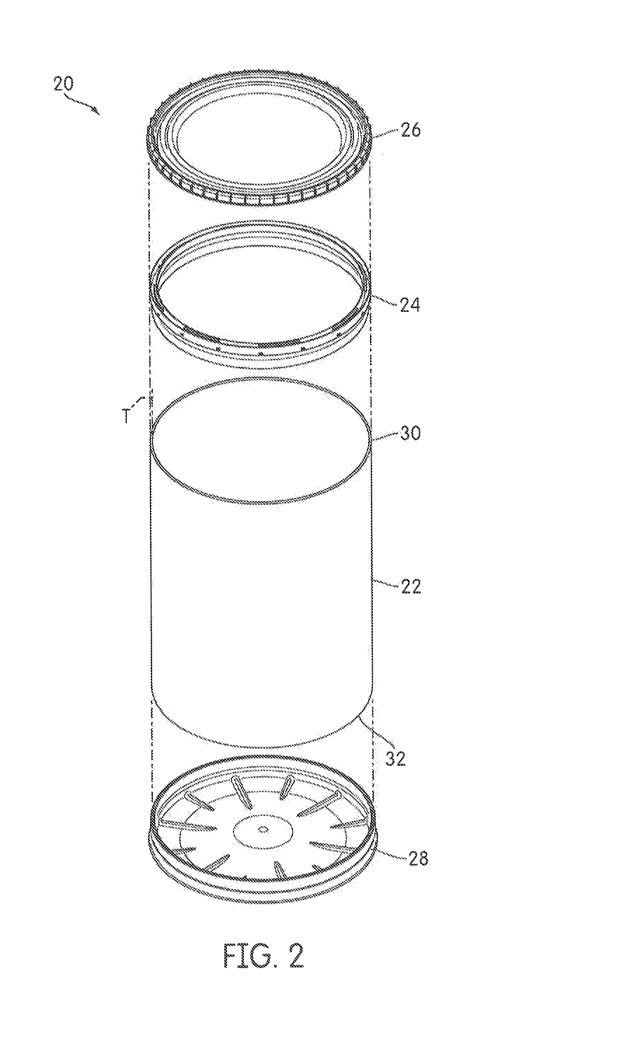

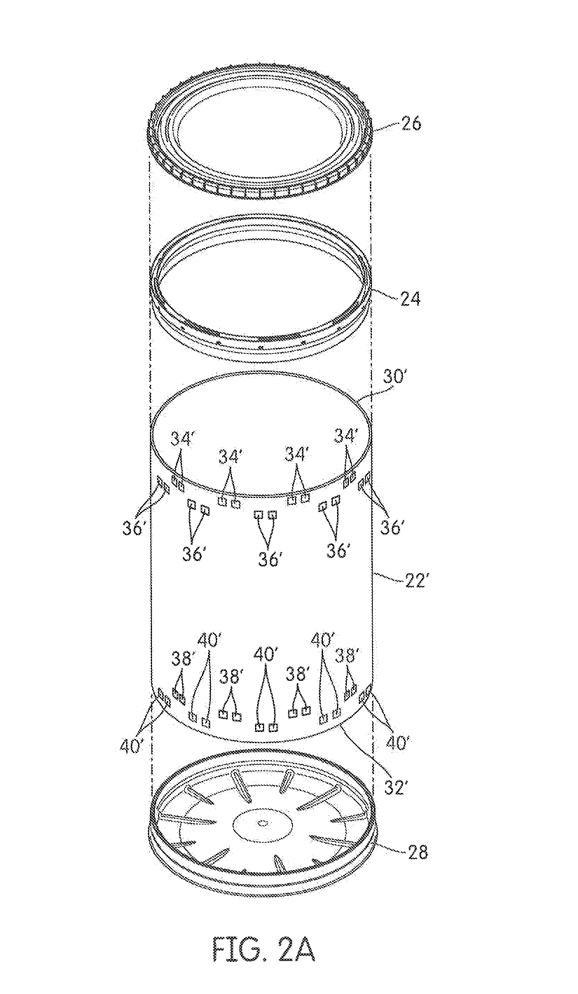

Referring to FIG. 2, an embodiment of a drum 20 is illustrated in an exploded configuration. The drum 20 includes an annular upper attachment, shown in FIG. 2 as a chime 24, an upper closure 26, and a lower closure 28. The sidewall 22 extends surrounding a longitudinal axis from a first end 30 to a second end 32. The lower closure 28 is configured to be coupled to the second end 32 of the sidewall 22, closing the second end 32 of the sidewall. The chime 24 is configured to be coupled to the first end 30 of the sidewall 22. When the chime 24 is coupled to the first end 30 of the sidewall 22, the first end 30 of the sidewall 22 remains open and material to be placed within the drum 20 may enter through the first end 30 of the sidewall 22 with the chime 24 coupled to the sidewall 22. In one embodiment, the sidewall 22 is generally continuous, e.g., without apertures, perforations, etc. In one embodiment, the sidewall 22 has a thickness T. In one embodiment, the thickness T is between approximately 3 ply and approximately 13 ply (where a ply is approximately 0.0125 inches). In another embodiment, the thickness T is between approximately 4 ply and approximately 12 ply. In another embodiment, the thickness T is between approximately 5 ply and approximately 11 ply.

With reference to FIG. 2A, in another embodiment, a sidewall 22′ includes a plurality of apertures, illustrated in FIG. 2A as perforations, proximate the first end 30′. In one embodiment, the sidewall 22′ includes a plurality of top upper 34′ and lower 36′ pairs of square perforations. The top upper 34′ and lower 36′ pairs of perforations are offset relative to one another both in a direction parallel to the longitudinal axis of the sidewall 22′ and circumferentially around the sidewall 22′.

With further reference to FIG. 2A, in one embodiment, the sidewall 22′ also includes a plurality of apertures, illustrated as perforations in FIG. 2A, proximate the second end 32′. In one embodiment, the sidewall 22′ includes a plurality of bottom upper 38′ and lower 40′ pairs of square perforations. The bottom upper 38′ and lower 40′ pairs of perforations are offset relative to one another both in a direction parallel to the longitudinal axis of the sidewall 22′ and circumferentially around the sidewall 22′.

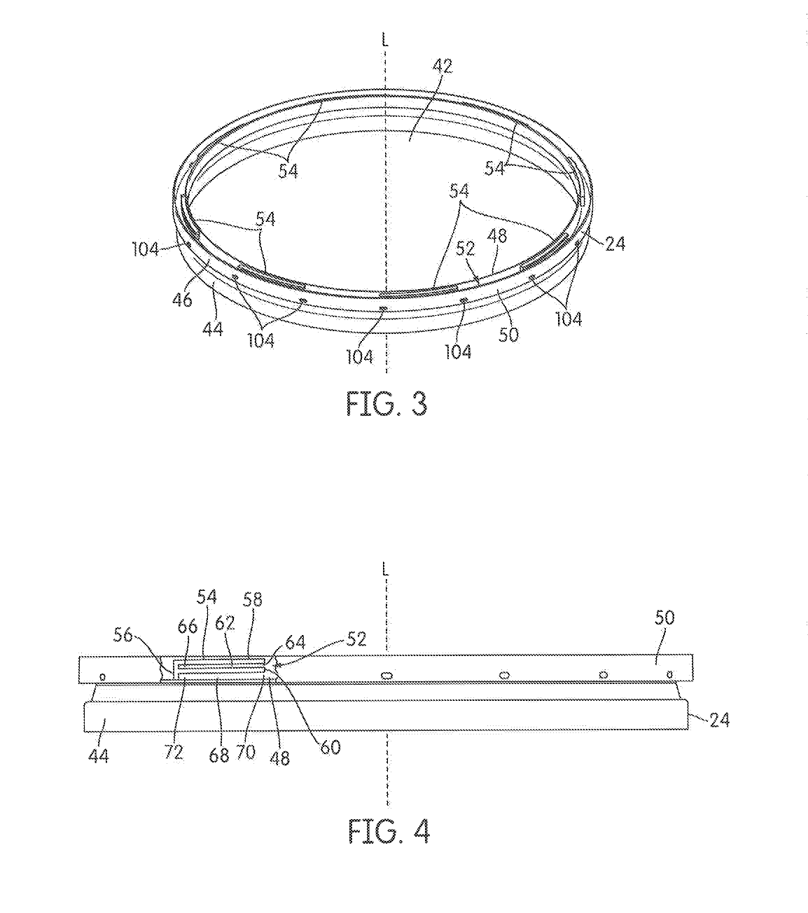

FIG. 3 illustrates an embodiment of a chime 24. In one embodiment, the chime 24 is generally annular surrounding a central longitudinal axis L and defines a central aperture 42 through which material may be placed into the drum 20 when the chime 24 is coupled to the sidewall 22. The chime 24 includes a lower portion 44 configured to be coupled to the sidewall 22 and an upper portion 46 to which the upper closure 26 is configured to be coupled. The upper portion 46 includes an inner wall 48 and an outer wall 50. The inner and outer walls 48 and 50 define a channel 52 therebetween. Extending radially outwardly into the channel 52 from the inner wall 48 are a plurality of discontinuous threading portions 54 spaced apart around the circumference of the inner wall 48.

With reference to FIGS. 3 and 4, in one embodiment, the thread portions 54 each include an end wall 56 extending generally parallel to the longitudinal axis of the chime 24, an upper wall 58 and a lower wall 60. The upper wall 58 and the lower wall 60 extend generally parallel to one another and circumferentially away from the end wall 56 generally perpendicular to the end wall 56. Defined between the upper wall 58 and the lower wall 60 is an upper channel 62. The upper channel 62 extends from a first open end 64 to a second closed end 66 closed by the end wall 56. Defined between the lower wall 60 and the lower periphery of the channel 52 is a lower channel 68. The lower channel 68 extends from a first open end 70 to a second closed end 72 closed by the end wall 56. As will be further described below, the channel 52 is configured to receive a sidewall of the upper closure 26 therein. Threaded portions of the sidewall are received into the upper and lower channels 62 and 68 to couple the upper closure 26 to the chime 24. In one embodiment, the chime 24 includes eight discontinuous threading portions 54 spaced equal circumferential distances apart around the inner wall 48. In other embodiments, the chime 24 may include any other suitable number of discontinuous threading portions 54.

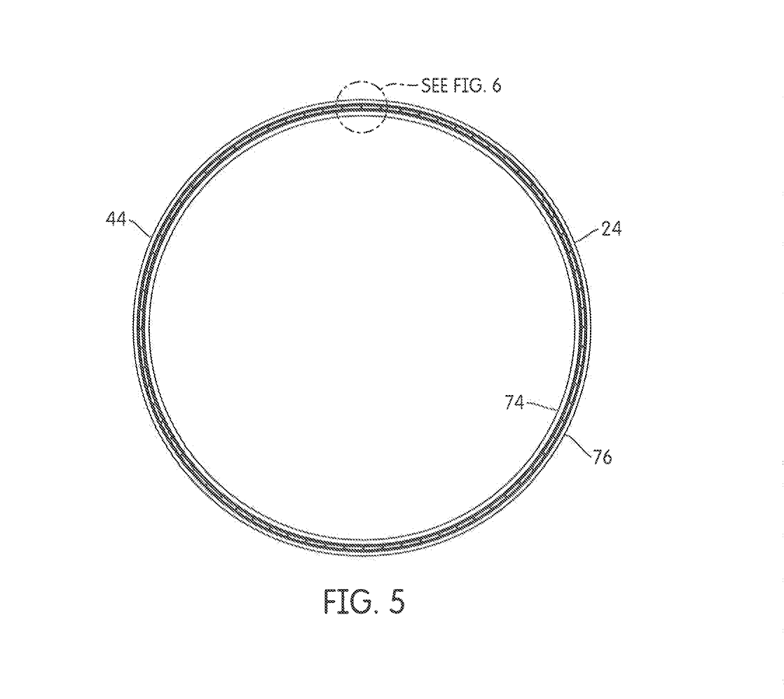

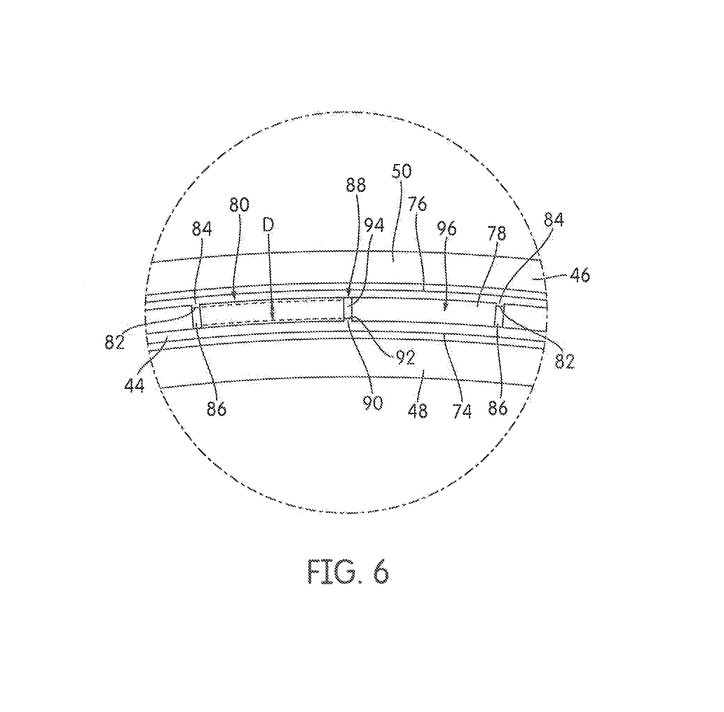

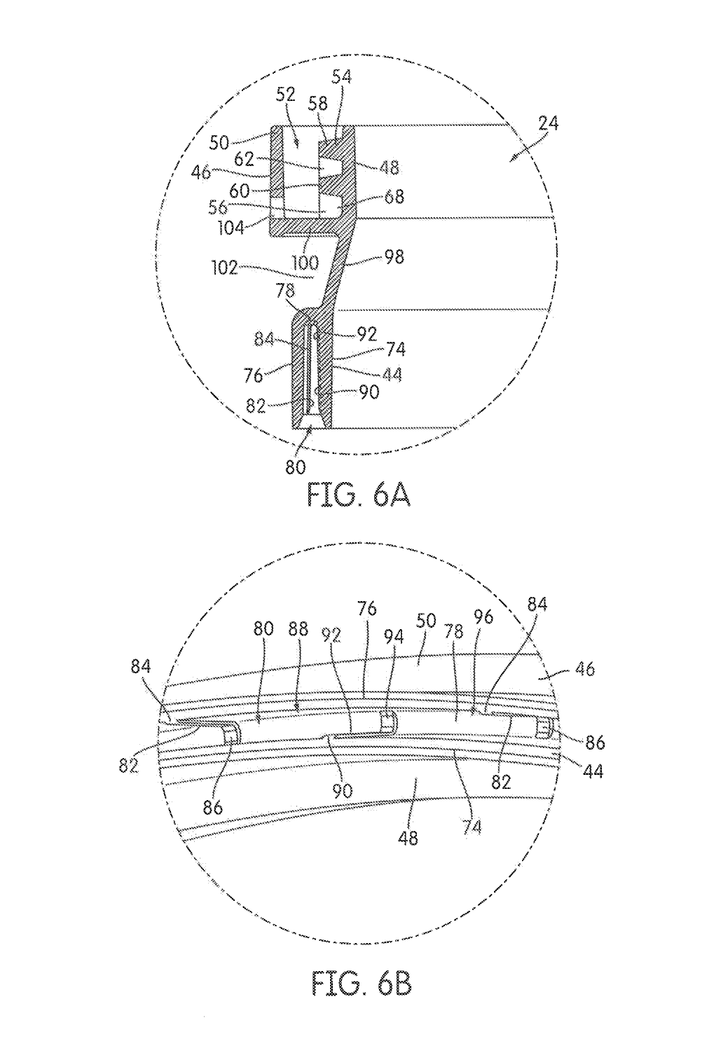

With reference to FIG. 5, in one embodiment, the lower portion 44 of the chime 24 includes an inner wall 74 and an outer wall 76. With reference to FIGS. 6-6B, an upper channel wall 78 extends between the inner wall 74 and the outer wall 76 proximate their upper axial peripheries. The inner wall 74, outer wall 76, and upper channel wall 78 define a downwardly-facing channel 80. The inner wall 74 and the outer wall 76 each have a beveled or chamfered axial lower end, providing easy access to the channel 80 by a sidewall.

With further reference to FIGS. 6-6B, in one embodiment, extending from the outer wall 76 are a plurality of ribs 82, e.g., upside down, generally L-shaped ribs, extending inwardly into the channel 80. The ribs 82 are spaced apart around the inner surface of the outer wall 76. In one embodiment, the ribs 82 are each spaced between approximately 5° and approximately 20° apart from the ribs 82 on either side. In another embodiment, the ribs 82 are each spaced apart approximately 10° from the ribs 82 on either side.

In one embodiment, the ribs 82 include a first portion 84 extending axially upwardly away from the open end of the channel 80 to the upper channel wall 78 in a direction generally parallel with the longitudinal axis L and a second portion 86 extending from the first portion 84 radially inwardly to the inner wall 48 and axially downwardly from the upper channel wall 78 into the channel 80. The ribs 82 define a channel 88 therebetween. The ribs 82 are configured to space a sidewall inserted into the channel 80 away from the outer wall 76 and the upper channel wall 78, with the channel 88 configured to allow adhesive flow around the sidewall inserted into the channel 80 to allow distribution, e.g., generally even distribution, of the adhesive around the sidewall, as will be further described below. In one embodiment, the radially inner surface of the first portion 84 of the ribs 84 extends parallel to the longitudinal axis L of the chime 24. In another embodiment, the radially inner surface of the first portion 84 of the ribs 82 extends non-parallel to the longitudinal axis L of the chime 24. The radially inner surface of the first portion 84 extends axially upwardly and radially inwardly. In one embodiment, the radially inner surface of the first portion 84 extends at an angle of between approximately 0° and approximately 5° relative to vertical. In another embodiment, the radially inner surface of the first portion 84 extends at an angle of approximately 1° relative to vertical. In another embodiment, the radially inner surface of the first portion 84 is generally parallel to vertical. In one embodiment, the second portions 86 of the ribs 82 are circumferentially offset from the first portions 84 of the ribs 82.

With further reference to FIGS. 6-6B, in one embodiment, extending from the inner wall 74 are a plurality of ribs 90, e.g., upside down, generally L-shaped ribs, extending radially inwardly into the channel 80. The ribs 90 are spaced apart around the outer surface of the inner wall 74. In one embodiment, the ribs 90 are each spaced between approximately 5° and approximately 20° apart from the ribs 90 on either side. In another embodiment, the ribs 90 are each spaced apart approximately 10° from the ribs 90 on either side. In one embodiment, the ribs 90 are each spaced 5° degrees apart from each of the ribs 82 on either side.

In one embodiment, the ribs 90 include a first portion 92 extending axially upwardly away from the open end of the channel 80 in a direction generally parallel to the longitudinal axis L to the upper channel wall 78 and a second portion 94 extending from the first portion 92 radially outwardly to the outer wall 76 and axially downwardly from the upper channel wall 78 into the channel 80. The ribs 90 define a channel 96 therebetween. The ribs 90 are configured to space a sidewall inserted into the channel 80 away from the inner wall 74 and the upper channel wall 78, with the channel 96 configured to allow adhesive flow around the sidewall inserted into the channel 80 to allow distribution, e.g., generally even distribution, of the adhesive around the sidewall, as will be further described below. In one embodiment, the radially outer surface of the first portion 92 of the ribs 90 extends parallel to the longitudinal axis L of the chime 24. In another embodiment, the radially outer surface of the first portion 92 of the ribs 90 extends non-parallel to the longitudinal axis L of the chime 24. The radially outer surface of the first portion 92 extends axially upwardly and radially inwardly. In one embodiment, the radially inner surface of the first portion 92 extends at an angle of between approximately 0° and approximately 5° relative to vertical. In another embodiment, the radially inner surface of the first portion 92 extends at an angle of approximately 1° relative to vertical. In another embodiment, the radially inner surface of the first portion 92 is generally parallel to vertical. In one embodiment, the second portions 94 of the ribs 90 are circumferentially offset from the first portions 92 of the ribs 90.

With reference to FIG. 6, in one embodiment, the ribs 82 and 90 are separated by a radial distance D. In one embodiment, the distance D is approximately equal to the thickness T of the sidewall 22 (see FIG. 2). Thus, adhesive flow around the sidewall 22 is allowed to allow distribution, e.g., generally even distribution, of the adhesive around the sidewall. In one embodiment, adhesive is allowed to distribute between the end of the sidewall and the upper channel wall 78 between the second portions of the ribs. In one embodiment, the distance D is between approximately 0.001 inches and approximately 0.2 inches. In another embodiment, the distance D is between approximately 0.0375 inches and approximately 0.1625 inches.

In one embodiment, the ribs 82 and 90 extend to a location approximately 0.05 inches above the upper channel wall 78. In one embodiment, the second portions 86 and 94 extend a distance of approximately 0.05 inches upwardly from the upper channel wall 78.

With reference to FIG. 6A, in one embodiment the chime 24 includes an angular wall 98 extending between the lower portion 44 and the upper portion 46. The angular wall 98 extends axially upwardly and radially inwardly from the lower portion 44 to the upper portion 46. In one embodiment, the angular wall 98 extends at an angle of between approximately 0° and approximately 60° relative to vertical. In another embodiment, the angular wall 98 extends at an angle of approximately 15° relative to vertical. In one embodiment, a lower wall 100 of the upper portion 46, the angular wall 98, and the upper channel wall 78 of the lower portion 44 define an outwardly facing channel 102. The outwardly facing channel 102 is configured to receive apparatus therein to lift, maneuver, move, etc. a drum. For example, in one embodiment, machinery including mechanical fingers may be placed into the channel 102 and upwardly directed force may be applied to the chime 24, e.g., the lower wall 100, to lift and maneuver a drum and its contents.

With further reference to FIG. 6A, in one embodiment, the outer wall 50 of the upper portion 46 defines a plurality of vents 104 around the circumference of the outer wall 50. In one embodiment, the vents 104 are configured to allow fluid, e.g., air to escape from the channel 52. In another embodiment, the vents 104 allow a tamper evident device to secure the cover 26 and chime 24 together.

In one embodiment, the ribs 82 and 90 each extend a maximum distance of between approximately 0.005 inches and approximately 0.125 inches into the channel 80. In another embodiment, the ribs 82 and 90 each extend a maximum distance of approximately 0.0014 inches into the channel 80.

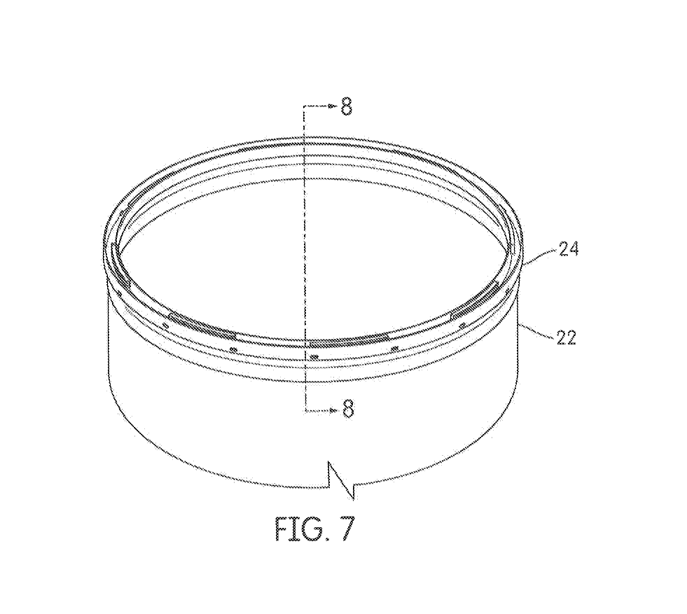

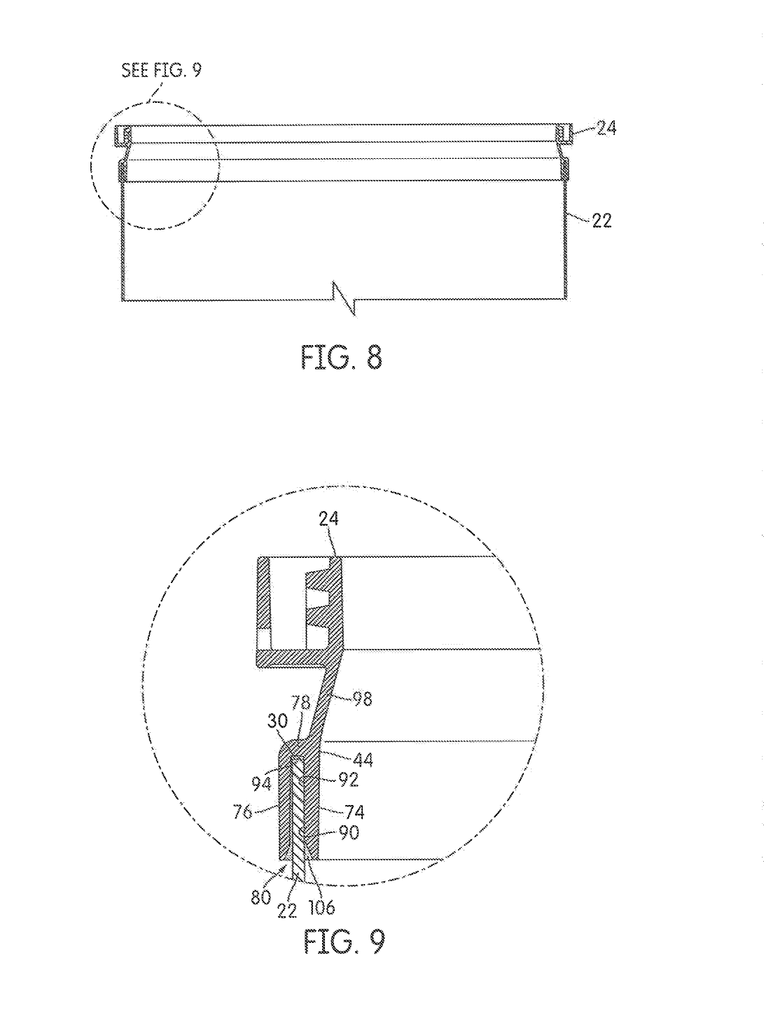

With reference to FIGS. 7-9, in one embodiment adhesive 106 is deposited into the channel 80 of the chime 24. Then, a sidewall 22 is inserted into the channel 80 of the chime 24. The ribs 82 (not visible in FIG. 9) and 90 provide spacing between the sidewall 22 and the surfaces of the outer 76 and inner 74 walls respectively and from the upper channel wall 78, allowing adhesive to flow and distribute around the sidewall 22 as the sidewall 22 is moved into the channel 80. Even distribution of adhesive may provide for consistent and strong adhesion between the chime 24, the adhesive 106, and the sidewall 22. In one embodiment, the chime 24 is coupled to the sidewall 22 without the chime 24 penetrating or deforming the outer surface of the sidewall 22, which may result in sidewall strength, durability, etc. In other embodiments, adhesive may be applied to the sidewall 22 and then the sidewall 22 is inserted into the channel 80.

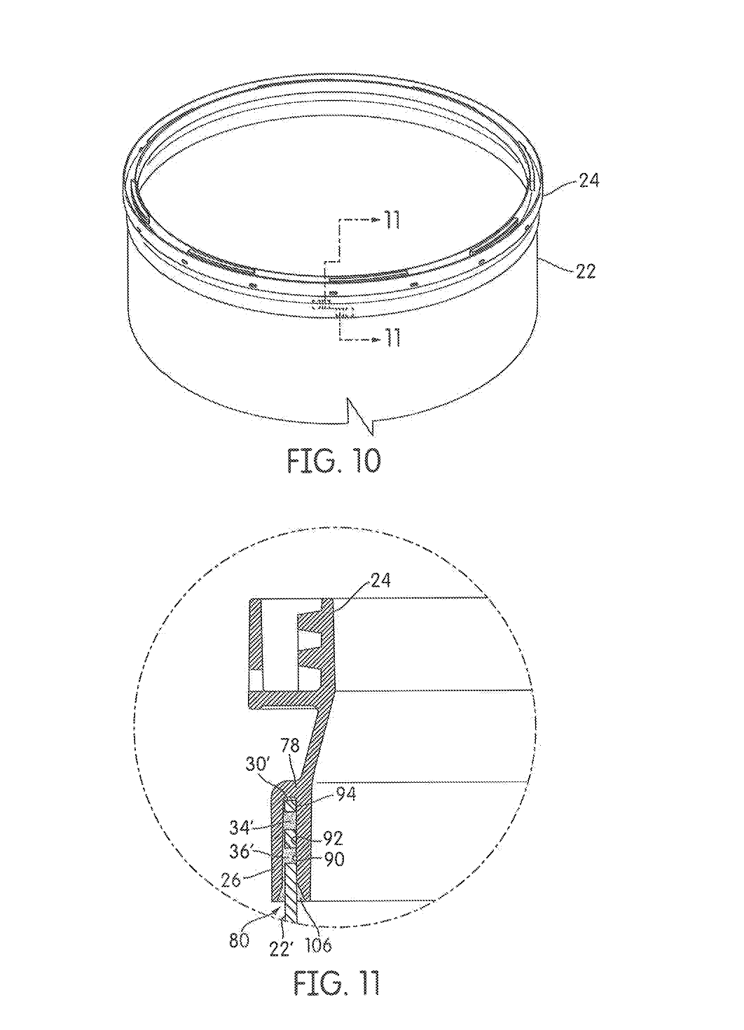

With reference to FIGS. 10 and 11, in another embodiment, the sidewall 22′ with perforations 34′ and 36′ is inserted into the channel 80 of the chime 24. The ribs 82 and 90 provide spacing between the sidewall 22′ and the surfaces of the outer 76 and inner 74 walls respectively and from the upper channel wall 78, allowing adhesive to flow and distribute around the sidewall 22′ as the sidewall 22′ is moved into the channel 80. The adhesive 106 extends through the perforations 34′ and 36′ and when cured forms a bridge therethrough which may act to secure the sidewall 22′ in the channel 80.

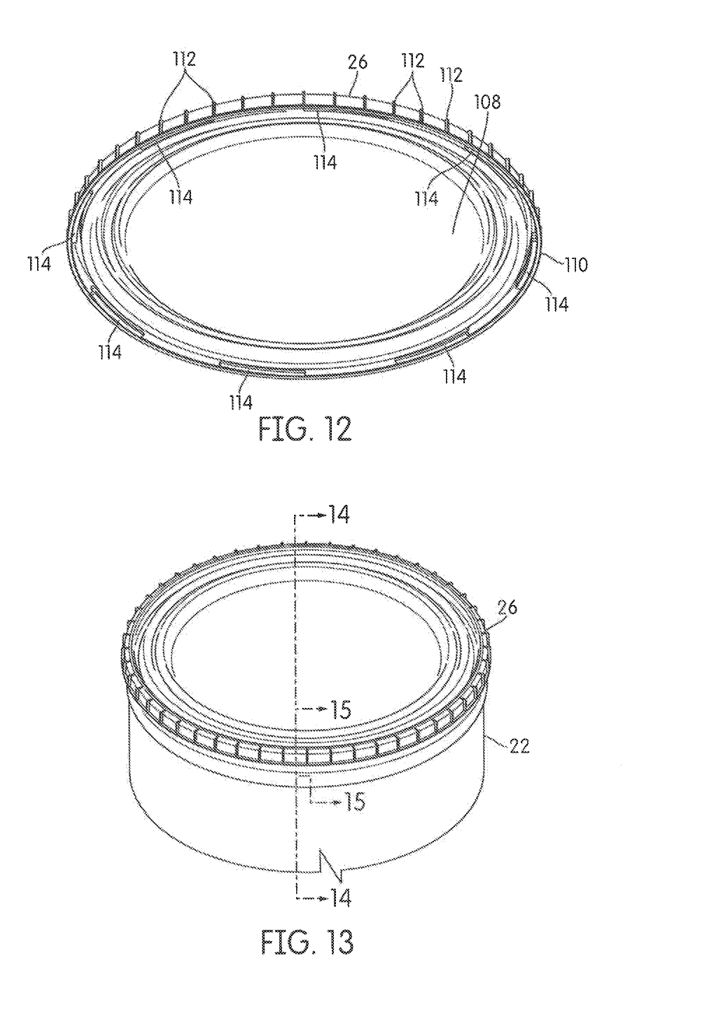

With reference to FIG. 12, an embodiment of an upper closure 26 is illustrated. The upper closure 26 includes a central portion 108 and a sidewall 110 extending axially downwardly from the radial periphery of the central portion 108. Extending radially outwardly and axially downwardly along the sidewall 110 are a plurality of ribs 112 (only some ribs 112 labelled in FIG. 12 for clarity). Extending radially inwardly from the sidewall 110 are a plurality of discontinuous threads 114. In the illustrated embodiment, eight discontinuous threads 114 are provided. In other embodiments, other suitable numbers of threads may be used. The discontinuous threads 114 are configured to allow the upper closure 26 to be rotated less than 360° to remove the upper closure 26 from the chime 24, as will be further explained below.

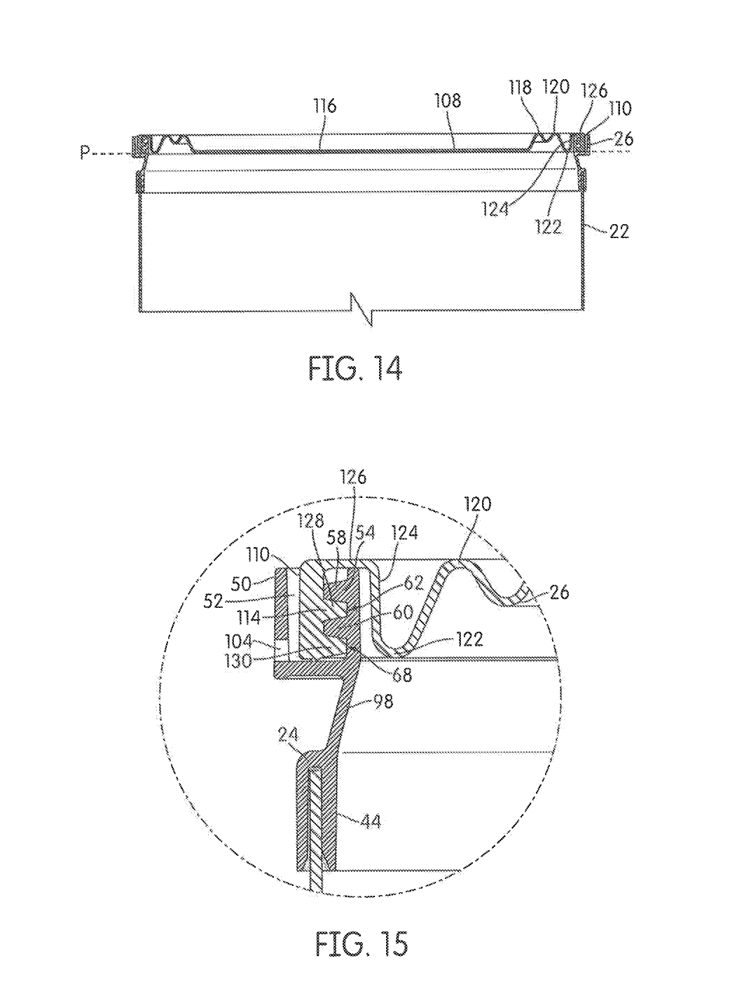

With reference to FIG. 14, in one embodiment, the central portion 108 includes a central disk portion 116 extending radially outwardly along a first plane P to an inner rib portion 118 extending generally circularly around the central disk portion 116. The inner rib portion 118 extends radially outwardly and axially upwardly to a peak located axially higher than the first plane P along which the central disk portion 116 extends. The central portion 108 also includes an outer generally circular rib portion 120 located radially outwardly from the inner rib portion 118. The outer rib portion 120 extends radially outwardly and axially upwardly to a peak located axially higher than the first plane P along which the central disk portion 116 extends. Extending radially outwardly from the radial periphery of the outer rib portion 120 is a trough portion 122 which extends radially outwardly to an axially extending inner sidewall 124. The inner sidewall 124 extends axially outwardly from the trough 122 to a transition portion 126 that extends radially outwardly to the axial upper periphery of the sidewall 110.

With reference to FIG. 15, in one embodiment, the discontinuous threads 114 each include an upper circumferentially extending wall 128 and a lower circumferentially extending wall 130. To couple the upper closure 26 to the chime 24, the sidewall 110 of the upper closure 26 is located in the channel 52 of the chime 24 with the discontinuous threads 114 located circumferentially between the discontinuous threading portions 54. The upper closure 26 is then rotated about its longitudinal axis relative to the chime 24 moving the upper wall 128 into the upper channel 62 and the lower wall 130 into the lower channel 68. The end wall 56 (not visible in FIG. 15) stops rotation of the upper closure 26 when the upper 128 and lower 130 walls reach the end wall 56. The outer wall 50 of the chime 24 may prevent access to the radial outer surface of the sidewall 110, which may prevent accidental rotation of the upper closure 26 relative to the chime 24 and or accidental decoupling of the upper closure 26 from the chime 24.

In one embodiment, the discontinuous threading portions 54 and the discontinuous threads 114 are configured such that the upper closure 26 and the chime 24 may be rotated relative to one another less than 360° to disengage the discontinuous threads 114 from the discontinuous threading portions 54 to uncouple the upper closure 26 from the chime 24.

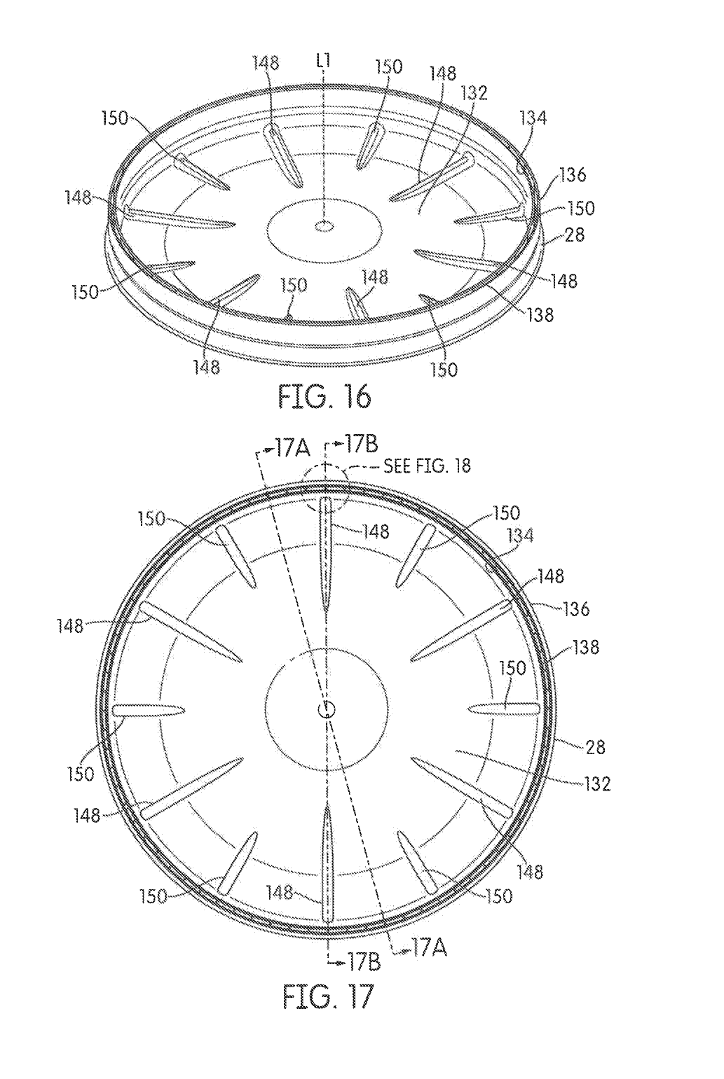

With reference to FIG. 16, an embodiment of a lower closure 28 is illustrated. The lower closure 28 includes a central portion 132 extending radially outwardly from a central longitudinal axis L1 and a pair of sidewalls 134 and 136 extending axially upwardly proximate the radial periphery of the central portion 132. The sidewalls 134 and 136 define a channel 138 therebetween configured to receive a sidewall 22 therein.

With reference to FIGS. 16-17B, in one embodiment, the central portion 132 includes an axial peak 140 proximate its radial center. The central portion 132 includes a first transition portion 142 extending radially outwardly and angularly downwardly from the peak 140 at a first slope. Extending radially outwardly from the first transition portion 142 is an annular second transition portion 144. The second transition portion 144 extends angularly downwardly at a second slope greater than the first slope to an outer annular portion 146. The outer annular portion 146 extends along a plane radially outwardly to the inner sidewall 134. Defined in central portion 132 are a plurality of radially inwardly extending rib portions 148 and 150. The rib portions 148 and 150 are axially raised portions extending radially inwardly from the inner sidewall 134 toward the longitudinal axis L1. The rib portions 148 extending farther radially inwardly than the rib portions 150. The rib portions 148 and 150 may strengthen the lower closure 28.

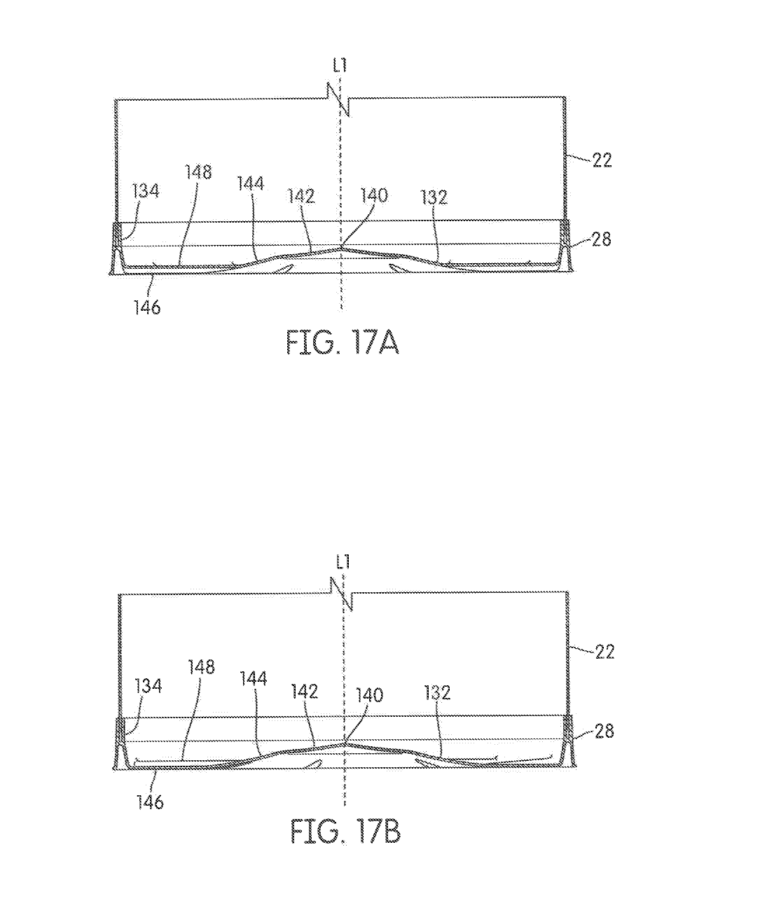

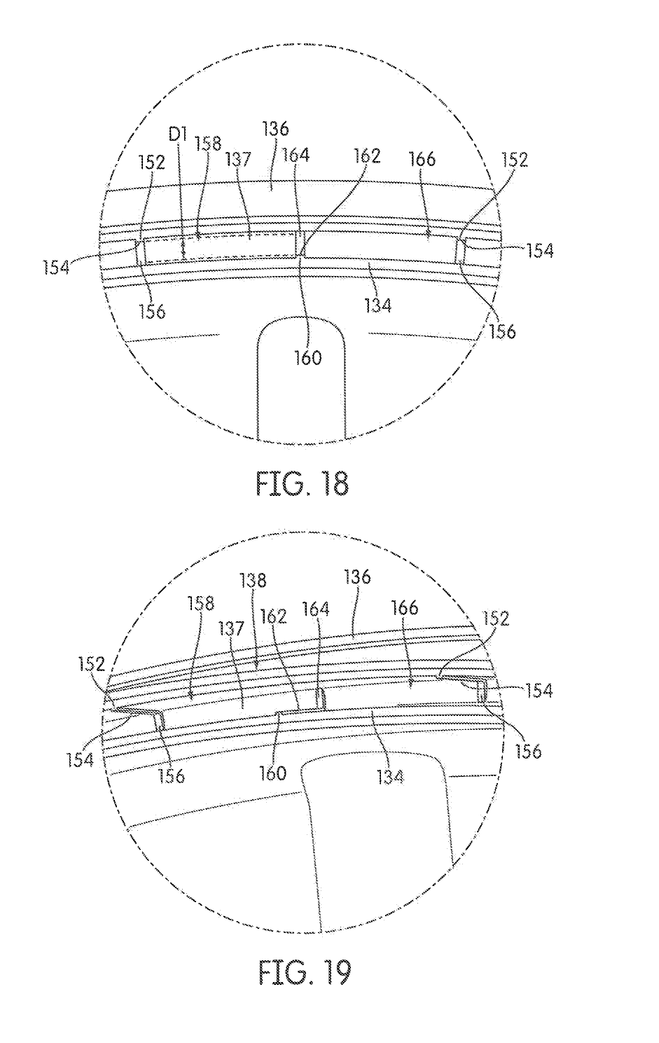

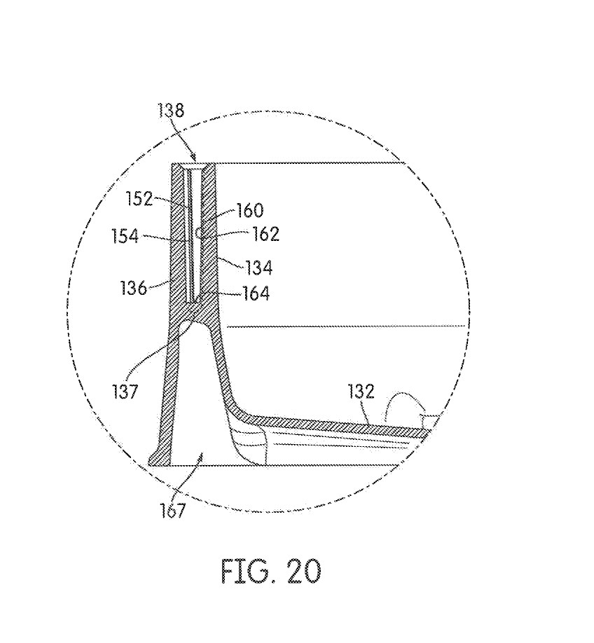

With reference to FIGS. 18-20, extending between the sidewalls 134 and 136 is an intermediate wall, shown as channel wall 137. The inner sidewall 134, an upper surface of the channel wall 137, and the outer sidewall 136 define an upwardly opening channel 138 configured to receive the second end 32 of the sidewall 22 therein. The lower closure 28 includes a first set of ribs 152, e.g., generally L-shaped ribs, spaced apart around the lower closure 28. In one embodiment, the ribs 152 are each located between approximately 5° and approximately 20° from the ribs 152 on either side. In another embodiment, the ribs 152 are each located approximately 10° from the ribs 152 on either side.

In one embodiment, the ribs 152 each include a first portion 154 extending axially downwardly away from the open end of the channel 138 in a direction generally parallel with the longitudinal axis L1 and a second portion 156 extending from the first portion 154 radially inwardly to the inner sidewall 134 and axially upwardly from the channel wall 137 into the channel 138. The ribs 152 define a channel 158 therebetween. The ribs 152 are configured to space a sidewall inserted into the channel 138 away from the outer sidewall 136 and the channel wall 137, with the channel 138 configured to allow adhesive flow around the sidewall inserted into the channel 138 to allow distribution, e.g., generally even distribution, of the adhesive around the sidewall, as will be further described below. In one embodiment, the radially inner surface of the first portion 154 of the ribs 152 extends parallel to the longitudinal axis L1. In another embodiment, the radially inner surface of the first portion 154 of the ribs 152 extends non-parallel to the longitudinal axis L1. The radially inner surface of the first portion 154 extends axially downwardly and radially inwardly. In one embodiment, the radially inner surface of the first portion 154 extends at an angle of between approximately 0° and approximately 5° relative to vertical. In another embodiment, the radially inner surface of the first portion 154 extends at an angle of approximately 1° relative to vertical. In one embodiment, the second portions 156 of the ribs 152 are circumferentially offset from the first portions 154.

With further reference to FIGS. 18-20, in one embodiment, extending from the inner sidewall 134 are a plurality of ribs 160, e.g., generally L-shaped ribs, spaced apart around radially outer surface of the inner sidewall 134 of the lower closure 28. In one embodiment, the ribs 160 are each located between approximately 5° and approximately 20° from the ribs 160 located on either side. In another embodiment, the ribs 160 are each located approximately 10° from the ribs 160 on either side.

The ribs 160 each include a first portion 162 extending axially downwardly away from the open end of the channel 138 in a direction generally parallel to the longitudinal axis L1 toward the channel wall 137 and a second portion 164 extending from the first portion 162 radially outwardly to the outer sidewall 136 and axially upwardly from the channel wall 137 into the channel 138. The ribs 160 define a channel 166 therebetween. The ribs 160 are configured to space a sidewall inserted into the channel 138 away from the inner sidewall 134 and the channel wall 137, with the channel 166 configured to allow adhesive flow around the sidewall inserted into the channel 138 to allow distribution, e.g., generally even distribution, of the adhesive around the sidewall, as will be further described below. The radially outer surface of the first portion 162 of the ribs 160 extends non-parallel to the longitudinal axis L1. The radially outer surface of the first portion 162 extends axially downwardly and radially inwardly. In one embodiment, the radially outer surface of the first portion 162 extends at an angle of between approximately 0° and approximately 5° relative to vertical. In another embodiment, the radially outer surface of the first portion 162 extends at an angle of approximately 1° relative to vertical. In one embodiment, the second portions 164 of the ribs 160 are circumferentially offset from the first portions 162.

With reference to FIG. 18, in one embodiment, the ribs 152 and 160 are separated by a radial distance D1. In one embodiment, the distance D1 is approximately equal to the thickness T of the sidewall 22 (see FIG. 2). Thus, adhesive flow around the sidewall 22 is allowed to allow distribution, e.g., generally even distribution, of the adhesive around the sidewall, including allowing distribution of adhesive below the sidewall between the channel wall 137 and the sidewall between the second portions 156, 164 of the ribs 152, 160. In one embodiment, the distance D1 is between approximately 0.001 inches and approximately 0.2 inches. In another embodiment, the distance D1 is between approximately 0.0375 inches and approximately 0.1625 inches.

In one embodiment, the ribs 152 and 160 extend to a location approximately 0.05 inches above the channel wall 137. In one embodiment, the second portions 156 and 164 extend a distance of approximately 0.05 inches upwardly from the channel wall 137.

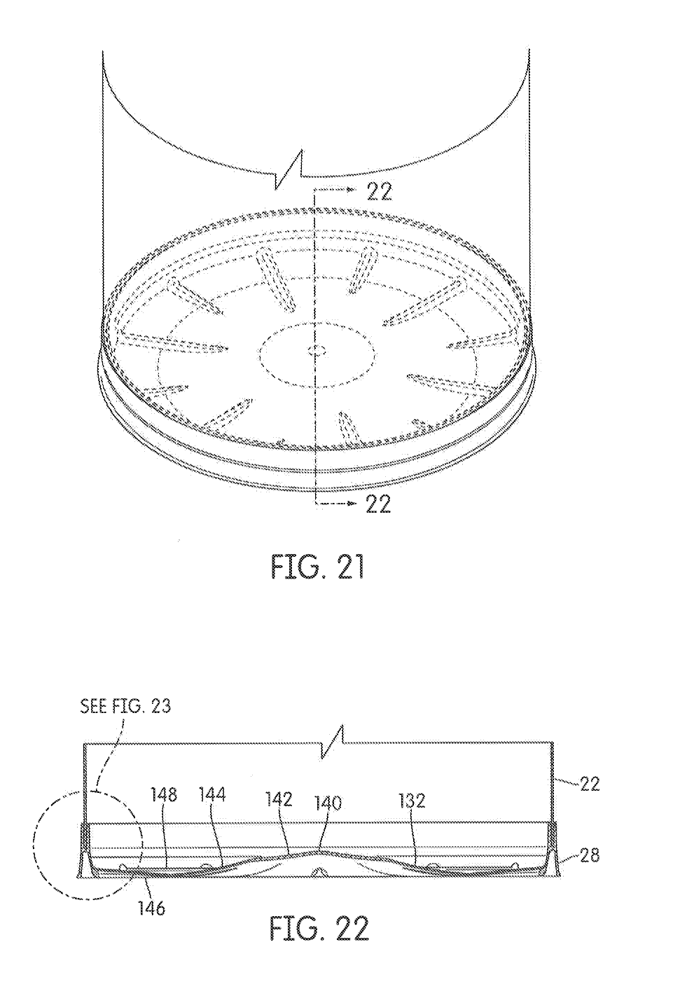

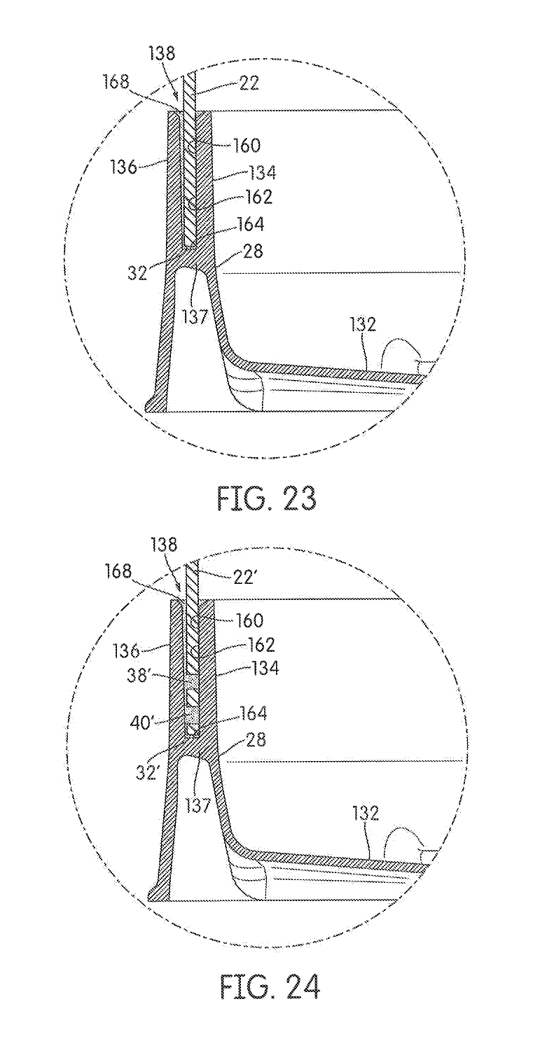

With reference to FIGS. 21-23, in one embodiment, adhesive 168 is deposited into the channel 138 of the lower closure 28. Then, a sidewall 22 is inserted into the channel 138 of the lower closure 28. The ribs 152 (not visible in FIG. 23) and 160 provide spacing between the sidewall 22 and the surfaces of the outer 136 and inner 134 sidewalls respectively and from the channel wall 137, allowing adhesive to flow and distribute around the sidewall 22 as the sidewall 22 is moved into the channel 138. Even distribution of adhesive may provide for consistent and strong adhesive between the lower closure 28, the adhesive 168, and the sidewall 22. In one embodiment, the adhesive 168 is the same adhesive as adhesive 106 coupling the sidewall 22 to the chime 24. In another embodiment, the adhesive 168 may be different from the adhesive 106 coupling the sidewall 22 to the chime 24. In one embodiment, the lower closure 28 is coupled to the sidewall 22 without the lower closure 28 penetrating or deforming the outer surface of the sidewall 22, which may result in sidewall strength, durability, etc. In other embodiments, adhesive may be applied to the sidewall and then the sidewall 22 is inserted into the channel 138.

With reference to FIG. 24, in another embodiment, the sidewall 22′ with the perforations 38′ and 40′ is inserted into the channel 138 of the lower closure 28. The ribs 152 (not visible in FIG. 24) and 160 provide spacing between the sidewall 22′ and the surfaces of the outer 136 and inner 134 sidewalls respectively and from the channel wall 137, allowing adhesive to flow and distribute around the sidewall 22′ as the sidewall 22′ is moved into the channel 138. The adhesive 168 extends through the perforations 38′ and 40′ and when cured forms a bridge therethrough which may act to secure the sidewall 22′ in the channel 138.

The lower surface of the channel wall 137, the inner sidewall 134, and the outer sidewall 136 define a downwardly opening channel 167 configured to receive a mechanism therein to lift, maneuver, move, etc., the drum 20.

In one embodiment, the lower closure 28 is coupled to the sidewall 22 without the lower closure 28 penetrating or deforming the outer surface of the sidewall 22, which may result in better sidewall strength, durability, etc.

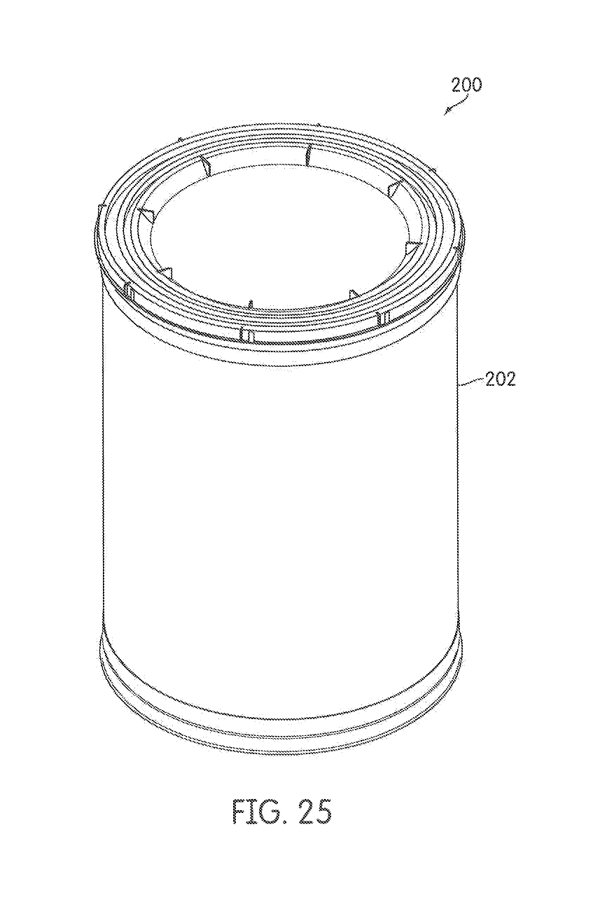

Referring to FIG. 25, another embodiment of a container, illustrated as a drum 200, is provided. The drum 200 includes a sidewall 202, such as a fiberboard sidewall. The drum 200 includes many of the same features, structure, configuration, etc., as the drum 20 described above. Therefore, differences from the drum 20 are the focus of the description below.

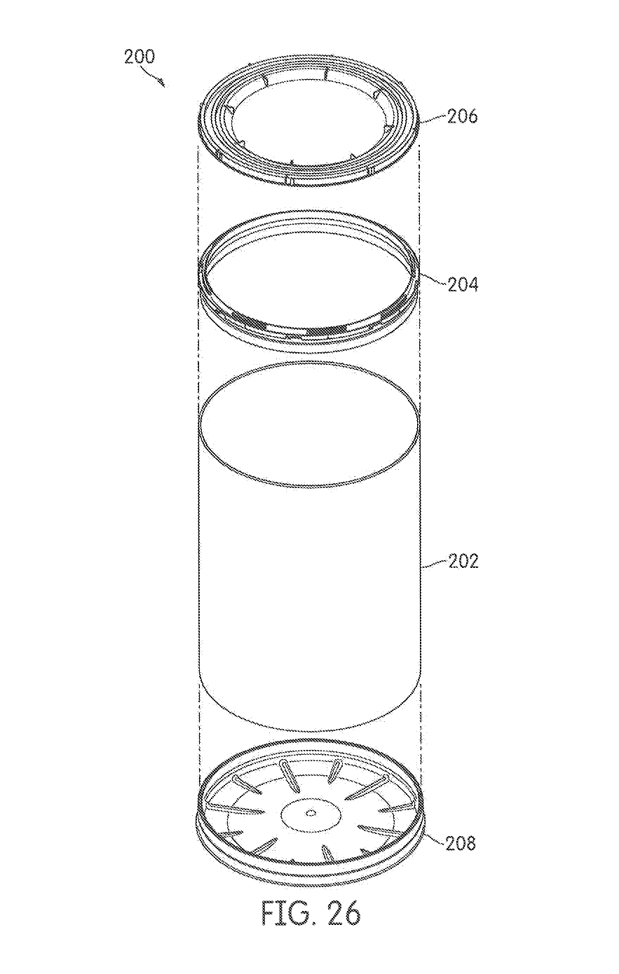

Referring to FIG. 26, the drum 200 is illustrated in an exploded configuration. The drum 200 includes an annular upper attachment, shown in FIG. 26 as a chime 204, an upper closure 206, and a lower closure 208.

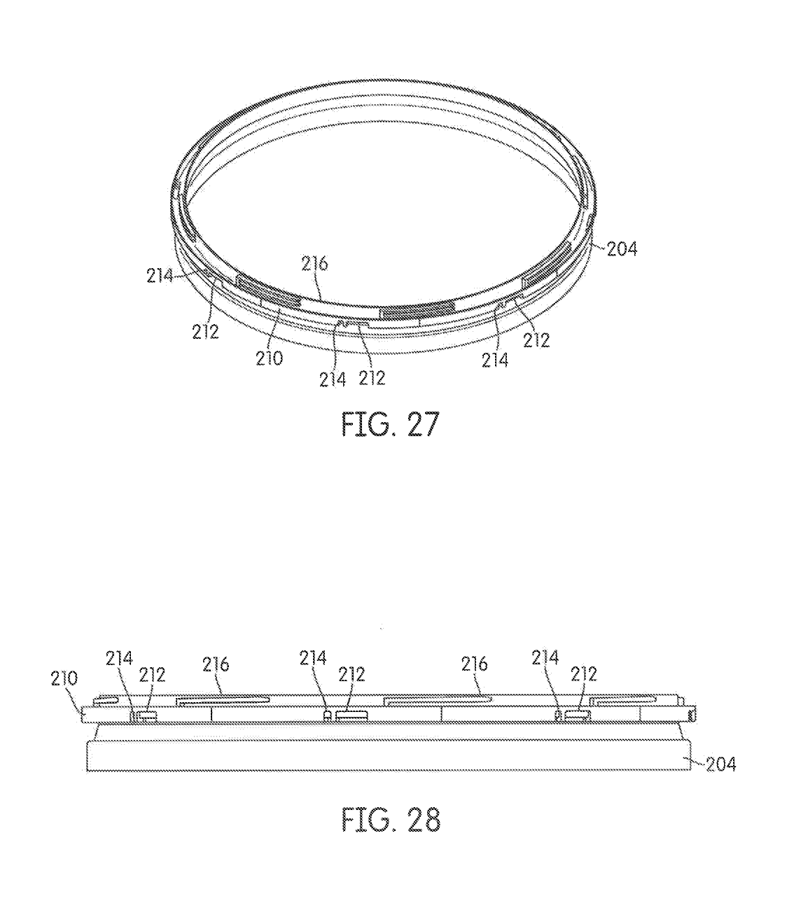

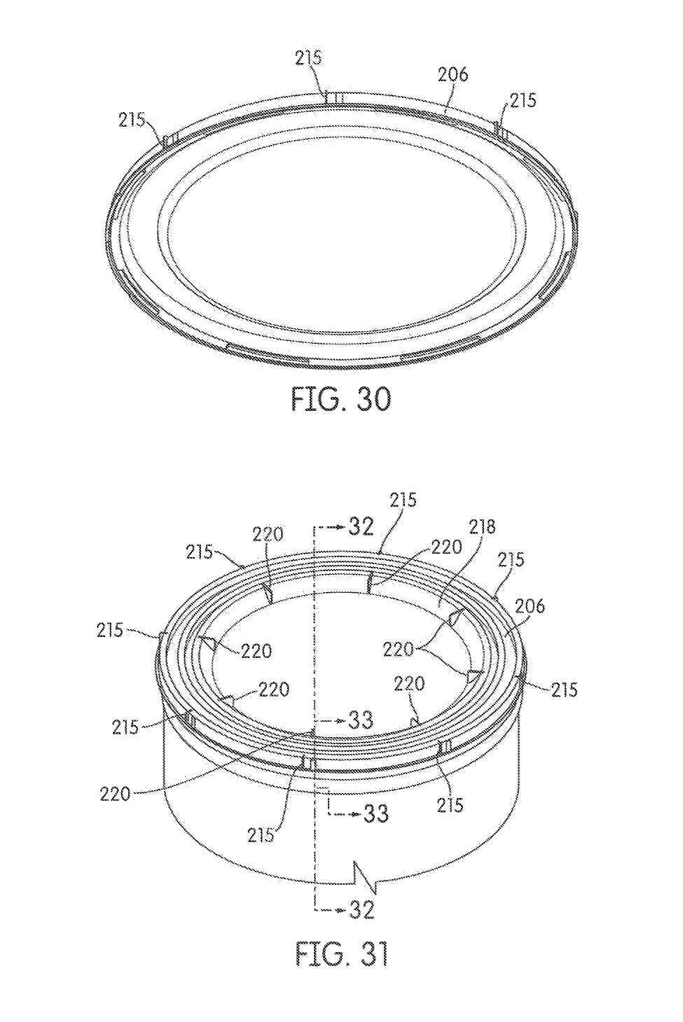

With reference to FIGS. 27 and 28, in one embodiment, the chime 204 includes an outer wall 210. Defined through the outer wall 210 proximate its lower periphery are pairs of windows 212 and 214 spaced apart circumferentially around the outer wall 210. The first wider windows 212 are configured to allow fluid to drain from the channel between the outer wall and an inner wall 216. The second narrower windows 214 are configured to each receive a tamper-indicating projection 215 (see FIGS. 30 and 31) of the closure 206 therethrough when the closure 206 is coupled to the chime 204. Thus if the closure 206 is removed from the chime 204, the tamper-indicating projections 215 will break from the closure 206, indicating that the closure 206 has been removed from the chime 204.

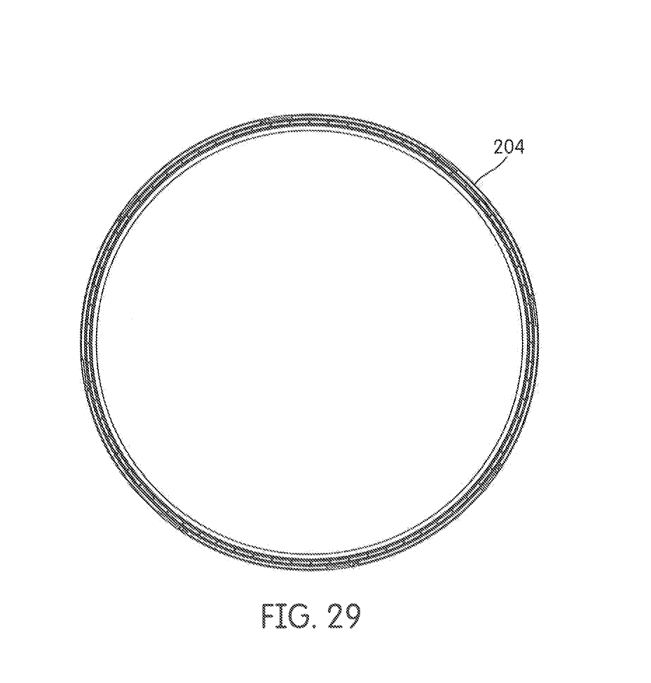

With reference to FIG. 29, in one embodiment, as in the embodiment described above, the chime 204 defines a channel into which the sidewall 202 is inserted. The chime 204 includes ribs projecting into the channel as in the embodiment described above.

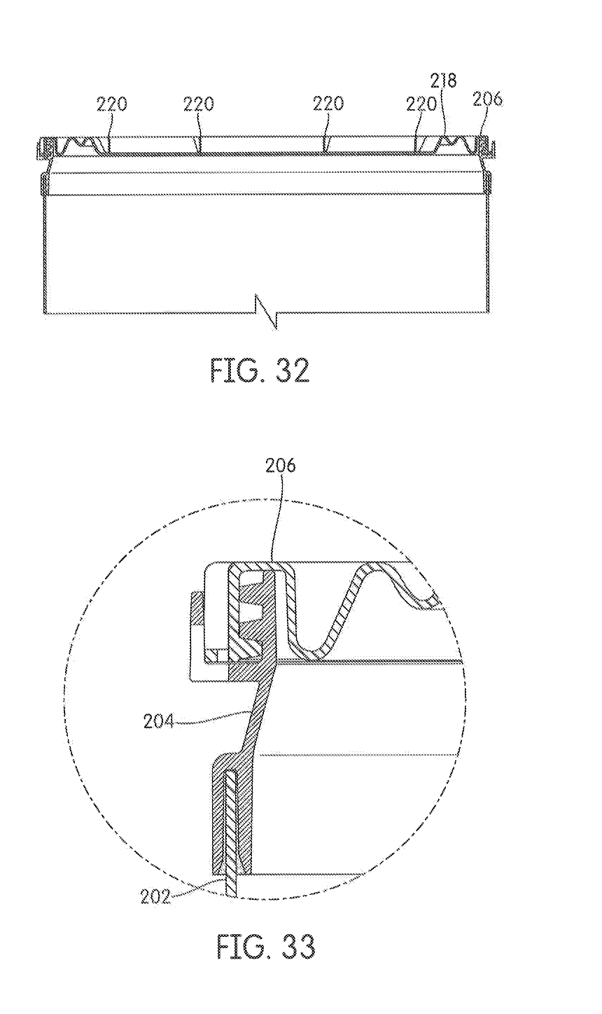

With reference to FIG. 30, an embodiment of a cover 206 is illustrated. The cover 206 includes a plurality of tamper-indicating projections 215 projecting radially outwardly. With reference to FIGS. 31 and 32, in one embodiment, the cover 206 includes a plurality of circumferentially spaced apart radially inwardly projecting strengthening rib projections 220 extending radially inwardly from the inner rib portion 218. The rib projections 220 are configured to strengthen and deter deflection and/or deformation of the cover 206.

With reference to FIGS. 3 and 4, in one embodiment, the thread portions 54 each include an end wall 56 extending generally parallel to the longitudinal axis of the chime 24, an upper wall 58 and a lower wall 60. The upper wall 58 and the lower wall 60 extend generally parallel to one another and circumferentially away from the end wall 56 generally perpendicular to the end wall 56. Defined between the upper wall 58 and the lower wall 60 is an upper channel 62. The upper channel 62 extends from a first open end 64 to a second closed end 66 closed by the end wall 56. Defined between the lower wall 60 and the lower periphery of the channel 52 is a lower channel 68. The lower channel 68 extends from a first open end 70 to a second closed end 72 closed by the end wall 56. As will be further described below, the channel 52 is configured to receive a sidewall of the upper closure 26 therein. Threaded portions of the sidewall are received into the upper and lower channels 62 and 68 to couple the upper closure 26 to the chime 24. In one embodiment, the chime 24 includes eight discontinuous threading portions 54 spaced equal circumferential distances apart around the inner wall 48. In other embodiments, the chime 24 may include any other suitable number of discontinuous threading portions 54.

In one embodiment, the drums 20 and 200 have a volume of between approximately 15 gallons and approximately 70 gallons. In another embodiment, the drums 20 and 200 have a volume of between approximately 50 gallons and approximately 65 gallons. In another embodiment, the drums have a volume of between approximately 55 gallons and approximately 60 gallons.

In one embodiment, the drums 20 and 200 may be filled with food product, liquids, parts, medicine, edible or non-edible solids or liquids, powder, dry granular material, or any other suitable material. In one embodiment, the drums 20 and 200 are configured to hold between approximately 100 pounds and approximately 1000 pounds of material.

In one embodiment, the drum 20 is configured to be engaged and moved by machinery (e.g., an overhead hoist, etc.) with a grip contacting an area approximately 4 inches wide on opposite sides of the drum 20, with the grips with approximately 4 inches wide contact with the drum 20 each disposed in the channel 102 (see, e.g., FIG. 6A), and configured to exert an upward force on the lower wall 100. In one embodiment, when the drum 20 is filled with approximately 800 pounds of material, the chime 24 and the sidewall 22 are coupled by the adhesive 106 and the lower closure 28 and the sidewall 22 are coupled by the adhesive 168 such that the drum 20 may be suspended by the approximately 4 inch wide grips disposed in the channel 102 for at least approximately 2 minutes without failure of the drum 20. In another embodiment, with the drum 20 filled with approximately 800 pounds of material, the chime 24 and the sidewall 22 are coupled by the adhesive 106 and the lower closure 28 and the sidewall 22 are coupled by the adhesive 168 such that the drum 20 may be suspended by the approximately 4 inch wide grips disposed on opposite sides of the drum 20 in the channel 102 for at least approximately 5 minutes without failure of the drum 20. In another embodiment, with the drum 20 filled with approximately 800 pounds of material, the chime 24 and the sidewall 22 are coupled by the adhesive 106 and the lower closure 28 and the sidewall 22 are coupled by the adhesive 168 such that the drum 20 may be suspended by the approximately 4 inch wide grips disposed on opposite sides of the drum 20 in the channel 102 for at least approximately 10 minutes without failure of the drum 20. In another embodiment, 1″ wide grips are used to perform the suspensions discussed above.

In one embodiment, the drum 20 is configured to meet and/or exceed various fiber drum regulations.

In one embodiment, the sidewall 22 is formed from a suitable fibrous material. In one embodiment, the fibrous material is fiberboard. In other embodiments, the sidewall 22 may be formed from any other suitable material. In one embodiment, the sidewall 22 is formed by rolling paper layers around a forming tube with an adhesive between layers to bond the layers. In other embodiments, the sidewall 22 may be formed by any other suitable mechanism. In one embodiment, the sidewall 22 is lined with a liner. In one embodiment, the liner is formed from plastic. In one embodiment, the plastic is high density polyethylene (HDPE). In another embodiment, the plastic may be any suitable thermoplastic. In other embodiments, the liner may be formed of any other suitable material.

In one embodiment, the adhesive 106 coupling the chime 24 to the sidewall 22 is a thermoplastic adhesive. In another embodiment, the adhesive 106 coupling the chime 24 to the sidewall 22 is a structural adhesive. In another embodiment, the adhesive 106 coupling the chime 24 to the sidewall 22 is an acrylic adhesive. In another embodiment, the adhesive 106 coupling the chime 24 to the sidewall 22 is a 2-part acrylic adhesive, such as, e.g., SCOTCH-WELD™ STRUCTURAL ADHESIVE DP 8005 (Translucent), produced by 3M Tapes & Adhesives Group and 3M Industrial Adhesives and Tapes Division. In other embodiments, any suitable type of adhesive may be used to couple the chime 24 to the sidewall 22.

In one embodiment, the adhesive 168 coupling the lower closure 28 to the sidewall 22 is a thermoplastic adhesive. In another embodiment, the adhesive 168 coupling the lower closure 28 to the sidewall 22 is a structural adhesive. In another embodiment, the adhesive 168 coupling the lower closure 28 to the sidewall 22 is an acrylic adhesive. In another embodiment, the adhesive 168 coupling the lower closure 28 to the sidewall 22 is a 2-part acrylic adhesive, such as, e.g., SCOTCH-WELD™ Structural Adhesive DP 8005 (Translucent), produced by 3M Tapes & Adhesives Group and 3M Industrial Adhesives and Tapes Division. In other embodiments, any suitable type of adhesive may be used to couple the lower closure 28 to the sidewall 22.

In one embodiment, the adhesives 106 and 168 each chemically react with the chime and lower closure respectively prior to curing and when placed in contact with the base and the chime. In one embodiment, the adhesives 106 and 168 chemically bond with plastic such as, for example, high density polyethylene, prior to curing and when placed in contact with the high density polyethylene.

In one embodiment of a method of providing a container, adhesive coupling the chime and bottom closure to the sidewall is a two-part adhesive and the method of providing the container includes mixing the two parts to form the adhesive. In one embodiment, the two parts are a methacrylate and an amine. In one embodiment, the adhesive is approximately 10 parts methacrylate to approximately 1 part amine. In another embodiment, the adhesive is approximately 9.16 parts methacrylate to approximately 1 part amine. In other embodiments, other suitable combinations may be used.

In one embodiment, the adhesives 106 and 168 are adhesives configured to bond polyolefins and low surface energy materials, e.g., fibrous materials, fiberboard, etc. In one embodiment, the overlap shear strength of the adhesives 106 and 168 at 75° Fahrenheit is greater than approximately 1000 psi. In another embodiment, the overlap shear strength of the adhesives 106 and 168 at 75° Fahrenheit is greater than approximately 2000 psi. In another embodiment, the overlap shear strength of the adhesives 106 and 168 at 75° Fahrenheit is approximately 2400 psi.

In one embodiment, the adhesives 106 and 168 are configured to bond to, for example, polyolefins without surface preparation of the polyolefins.

In one embodiment, LORD® 7542 urethane adhesive available from Lord Corporation may be used. In another embodiment, EPIC X11A4677 urethane adhesive available from Epic Resins may be used.

In one embodiment, by coupling the chime 24 and the lower closure 28 to the sidewall 22 with adhesive, the coupling may be accomplished cheaply, reliably, and accurately, without the use of additional parts (e.g., bolts, screws, pins, etc.), without the use of additional processes (e.g., crimping, sonic welding, twisting chime 24 and/or lower closure 28 onto the sidewall 22 so that threading penetrates and/or deforms the surface of the sidewall, etc.), and without the use of additional features (e.g., threading, etc.).

In one embodiment, chime 24, the upper closure 26, and the lower closure 28 are formed from plastic. In one embodiment, the chime 24, the upper closure 26, and the lower closure 28 are formed from high density polyethylene HDPE). In another embodiment, the chime 24, the upper closure 26, and the lower closure 28 are formed from polypropylene. In other embodiments, the chime 24, the upper closure 26, and the lower closure 28 may be formed from any suitable polyolefin. In other embodiments, the chime 24, the upper closure 26, and the lower closure 28 may be formed from any suitable synthetic resin. In other embodiments, the chime 24, the upper closure 26, and the lower closure 28 may be formed from any suitable type of thermosetting polymer or thermoplastic. In other embodiments, the chime 24, the upper closure 26, and the lower closure 28 may be formed by molding. In one embodiment, the chime 24, the upper closure 26, and the lower closure 28 may each be formed from different materials.

In another embodiment, a chime coupled to a sidewall as discussed above is provided. The chime includes a flange with a smooth contoured rib of approximately ¼″ wide with a full upper radius. In one embodiment, a cover is placed on the chime and a lock band is used to couple the cover to the chime. In one embodiment, the lock band has a “C” profile and the cover and chime are captured inside the “C” throat of the lock band. In one embodiment, a pivoting handle is locked into place to put tension on the lock band profile, which compresses the cover and the chime together to couple the cover to the chime and close the container.

In one embodiment, the sidewall 22 has a diameter between approximately 10 inches and approximately 30 inches. In one embodiment, the sidewall 22 has a diameter between approximately 15 inches and approximately 23 inches. In one embodiment, the sidewall 22 has a diameter of approximately 15.5 inches. In another embodiment, the sidewall 22 has a diameter of approximately 17 inches. In another embodiment, the sidewall 22 has a diameter of approximately 18.5 inches. In another embodiment, the sidewall 22 has a diameter of approximately 20 inches. In another embodiment, the sidewall 22 has a diameter of approximately 21.5 inches. In another embodiment, the sidewall 22 has a diameter of approximately 23 inches. In one embodiment, the diameter of the sidewall is an inner diameter. In other embodiments, the diameter of the sidewall is an outer diameter. In one embodiment, the sidewall 22 extends a length of between approximately 30 inches and approximately 44 inches. In another embodiment, the sidewall 22 extends a length of between approximately 33 inches and approximately 41 inches. In another embodiment, the sidewall 22 extends a length of approximately 37 inches.

Some plastics may resist harsh chemical and environmental conditions and may also resist chemical bonding, e.g., bonding to a dissimilar material. In one embodiment, the adhesives described herein may be adhesives that are maintained in liquid form prior to application to a chime or lower closure and include a weak acid acting as a stabilizer, with the adhesive configured to be activated by a weak base, e.g., moisture, to undergo an anionic polymerization reaction and to cure. In one embodiment, the adhesives described herein are configured to chemically react both with the chime and lower closure and with the sidewall. In one embodiment, an adhesive in a liquid form at between approximately 60° F. and approximately 80° F. may be applied in liquid form to the chime and lower closure and cures at between approximately 60° F. and approximately 80° F. bonding the chime and the lower closure to the sidewall. In one embodiment, the adhesives described herein are configured to attach both to the chime and to the sidewall, e.g., as opposed to fusing into a unified whole, such as with sonic welding in which in one embodiment there is no third material joining surfaces, e.g., sonic welding exciting the materials to a frequency to liquefy, the two surfaces becoming bonded. In one embodiment, an adhesive that is a separate structural member from a sidewall and a bottom closure or chime may be used to couple the sidewall to the bottom closure or the chime. In one embodiment, adhesive bonds two surfaces through a chemical process.

It should be understood that the figures illustrate the exemplary embodiments in detail, and it should be understood that the present application is not limited to the details or methodology set forth in the description or illustrated in the figures. It should also be understood that the terminology is for the purpose of description only and should not be regarded as limiting.

Further modifications and alternative embodiments of various aspects of the invention will be apparent to those skilled in the art in view of this description. Accordingly, this description is to be construed as illustrative only. The construction and arrangements, shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes and omissions may also be made in the design, operating conditions and arrangement of the various exemplary embodiments without departing from the scope of the present invention.

For purposes of this disclosure, the term “coupled” means the joining of two components directly or indirectly to one another. Such joining may be stationary in nature or movable in nature. Such joining may be achieved with the two members and any additional intermediate members being integrally formed as a single unitary body with one another or with the two members or the two members and any additional member being attached to one another. Such joining may be permanent in nature or alternatively may be removable or releasable in nature.

In various exemplary embodiments, the relative dimensions, including angles, lengths and radii, as shown in the Figures are to scale. Actual measurements of the Figures will disclose relative dimensions, angles and proportions of the various exemplary embodiments. Various exemplary embodiments extend to various ranges around the absolute and relative dimensions, angles and proportions that may be determined from the Figures. Various exemplary embodiments include any combination of one or more relative dimensions or angles that may be determined from the Figures. Further, actual dimensions not expressly set out in this description can be determined by using the ratios of dimensions measured in the Figures in combination with the express dimensions set out in this description.

What is claimed is:

1. A shipping drum comprising:
a fibrous cylindrical sidewall extending along a longitudinal axis from a first end to a second end and having an inner surface and an outer surface;
a lower closure formed from plastic and including a central portion extending radially outwardly from a central longitudinal axis and inner and outer walls extending generally parallel to the central longitudinal axis, the inner and outer walls located proximate the radial periphery of the central portion, a channel wall extending between the inner and outer walls, the outer wall, the inner wall, and the channel wall defining a channel configured to receive the second end of the sidewall therein, a first rib having a first portion extending radially outwardly into the channel from the inner wall and in a direction axially generally parallel to the central longitudinal axis and a second portion extending axially upwardly from the channel wall into the channel and radially outwardly from the inner wall to the outer wall; and
an adhesive coupling the sidewall to the inner and outer walls of the lower closure closing the second end of the cylindrical sidewall.

2. The shipping drum of claim 1, wherein the lower closure includes a second rib having a first portion extending radially inwardly into the channel from the outer wall and a second portion extending axially upwardly from the channel wall into the channel and radially inwardly from the outer wall to the inner wall.

3. The shipping drum of claim 2, wherein the first rib is circumferentially offset from the second rib.

4. The shipping drum of claim 1, wherein the inner wall includes an upper portion extending above the channel wall and a lower portion extending below the channel wall;
wherein the outer wall includes an upper portion extending above the channel wall and a lower portion extending below the channel wall; and
wherein the lower portion of the inner wall, the lower portion of the outer wall, and the channel wall define a lower channel.

5. The shipping drum of claim 4, wherein the central portion includes a first raised portion extending radially inwardly from the lower portion of the inner wall.

6. The shipping drum of claim 5, wherein the central portion includes a second raised portion extending radially inwardly from the lower portion of the inner wall circumferentially spaced apart from the first raised portion, the first raised portion extending a first radial distance from the lower portion of the inner wall, the second raised portion extending a second radial distance from the lower portion of the inner wall, the first radial distance being greater than the second radial distance.

7. The shipping drum of claim 1, wherein the central portion of the lower closure includes a raised radially inner portion, an lower radially outer portion, and a transition portion extending between the raised radially inner portion and the lower radially outer portion, the raised radially inner portion being located axially higher than the lower radially outer portion.

8. The shipping drum of claim 1, comprising a plastic chime including an inner wall, an outer wall, and a second channel wall extending between the inner wall and the outer wall, the inner, outer, and channel walls defining a channel configured to receive the first end of the sidewall therein, the chime including a first rib having a first portion extending radially outwardly from the inner wall into the channel and in a direction axially generally parallel to the central longitudinal axis and a second portion extending into the channel axially downwardly from the second channel wall and radially outwardly from the inner wall to the outer wall, the chime including a second rib having a first portion extending radially inwardly from the outer wall into the channel and in a direction axially generally parallel to the central longitudinal axis and a second portion extending axially downwardly from the second channel wall into the channel and radially inwardly from the outer wall to the inner wall; and
an adhesive in the channel between the inner wall and the outer wall of the chime coupling the sidewall to the inner and outer walls of the chime.

9. The shipping drum of claim 8, wherein the first rib of the chime is circumferentially offset from the second rib of the chime.

10. The shipping drum of claim 8, comprising a top closure configured to be coupled to the chime to close the first end of the sidewall, the top closure including a plurality of discontinuous threading portions;
wherein the chime includes a plurality of discontinuous threading portion configured to interact with the discontinuous threading portions of the top closure to couple the top closure to the chime.

11. The shipping drum of claim 10, wherein the top closure includes a lower central portion, a first generally circular raised rib extending around the lower central portion, and a second generally circular raised rib spaced apart and located radially outwardly from the first rib and extending around the first rib, each of the first and second ribs having an apex located axially higher than the surface of the lower central portion.

12. A shipping drum comprising:
a fibrous cylindrical sidewall extending along a longitudinal axis from a first end to a second end and having an inner surface and an outer surface;
a lower closure formed from plastic and including a central portion extending radially outwardly from a central longitudinal axis and inner and outer walls extending generally parallel to the central longitudinal axis, the inner and outer walls located proximate the radial periphery of the central portion, the inner and outer walls defining a channel therebetween configured to receive the second end of the sidewall therein, an outer surface of the inner wall defining a first axial channel extending axially generally parallel to the central longitudinal axis, an inner surface of the outer wall defining a second axial channel extending axially generally parallel to the central longitudinal axis; and
an adhesive coupling the sidewall to the inner and outer walls of the lower closure closing the second end of the cylindrical sidewall.

13. The shipping drum of claim 12, wherein the first axial channel and the second axial channel are circumferentially offset.

14. The shipping drum of claim 12, a plastic chime including an inner wall and an outer wall defining a channel therebetween configured to receive the first end of the sidewall therein, an outer surface of the inner wall defining a third axial channel extending generally parallel to the central longitudinal axis, an inner surface of the outer wall defining a fourth axial channel extending generally parallel to the central longitudinal axis; and
an adhesive in the channel between the inner wall and the outer wall of the chime coupling the sidewall to the inner and outer walls of the chime.

15. The shipping drum of claim 14, wherein the chime includes a second inner wall and a second outer wall spaced apart from the second inner wall, the second inner and outer walls defining an upper closure wall receiving channel therebetween, the second inner wall including a plurality of discontinuous thread portions.

16. The shipping drum of claim 15, comprising an upper closure including a downwardly extending radially peripheral wall having an inner surface and an outer surface, the inner surface defining discontinuous threads configured to interact with the discontinuous thread portions of the chime to couple the upper closure to the chime with the radially peripheral wall being located in the upper closure wall receiving channel.

17. A shipping drum comprising:
a fibrous cylindrical sidewall extending along a longitudinal axis from a first end to a second end and having an inner surface and an outer surface, the fibrous cylindrical sidewall having a first thickness;
a lower closure formed from plastic including inner and outer walls extending in a direction generally parallel to a central longitudinal axis of the lower closure and a first wall extending between the inner and outer walls, the inner and outer walls and the first wall defining a channel configured to receive the second end of the sidewall therein, the lower closure including a plurality of ribs spaced apart around the channel, the ribs extending from the first wall axially upwardly into the channel and radially outwardly from the inner wall to the outer wall; and
an adhesive coupling the sidewall to the inner and outer walls of the lower closure closing the second end of the cylindrical sidewall.

18. The shipping drum of claim 17, wherein the inner wall includes a first rib extending radially outwardly into the channel to a radially outer periphery and axially generally parallel to the central longitudinal axis and the outer wall includes a second rib extending radially inwardly into the channel to a radially inner periphery and axially generally parallel to the central longitudinal axis, the radially outer periphery of the first rib and the radially inner periphery of the of the second rib being a first radial distance apart, the first radial distance being equal to or greater than the first thickness.

19. The shipping drum of claim 17, wherein the lower closure includes high density polyethylene, the adhesive is a structural adhesive configured to chemically bond with high density polyethylene at temperatures between approximately 32° Fahrenheit and approximately 100° Fahrenheit, and the adhesive forms one of a thermoplastic resin and a thermosetting resin when cured.

20. A method of making a shipping drum comprising:
applying liquid adhesive into a channel of a plastic lower closure formed between inner and outer walls, the inner and outer walls extending in a direction generally parallel to a longitudinal axis of the lower closure, the inner wall including a first rib extending radially outwardly into the channel and in a direction generally parallel to the longitudinal axis, the outer wall including a second rib extending radially inwardly into the channel and in a direction generally parallel to the longitudinal axis; and
moving a first end of a generally cylindrical fibrous sidewall into the channel.
